(19) United States
(12) Patent Application Publication
(10) Pub. No.: US 2007/0293263 A1
(43) Pub. Date: Dec. 20, 2007

(54) Method and apparatus for providing multi-system cellular communications

(76) Inventors: Hossein Eslambolchi, Los Altos Hills, CA (US); Christopher W. Rice, Parsippany, NJ (US)

Correspondence Address: AT&T CORP., ROOM 2A207, ONE AT&T WAY, BEDMINSTER, NJ, 07921, US

(21) Appl. No.: 11/453,127

(22) Filed: Jun. 14, 2006

(51) Int. Cl. H04M 1/00

(52) U.S. Cl. 455/552.1

(57) ABSTRACT

A method and apparatus of communicating with a plurality of cellular communication networks employing different communication protocols using a single mobile endpoint device, e.g., a cellular phone, are disclosed. In one embodiment, a user cellular phone is provided with a communication protocol conversion or switching module that is adapted for interfacing with different cellular networks operating in a region where the cellular phone is presently located. When a request for an incoming call or an outgoing call is received, the present method evaluates at least one performance factor in selecting one of the plurality of different communication protocols to service or process the incoming call or outgoing call.

### BACKGROUND OF THE INVENTION

1. Field of the Invention

The present invention generally relates to a field of communication devices and, in particular, to user communication devices of cellular telephone networks.

2. Description of the Related Art

One of the solutions for expanding services of cellular telephone networks is offered by Mobile Virtual. Network Operators (MVNOs). A MVNO usually does not own any network infrastructures but instead enters into business agreements with various regional cellular telephone networks to buy the airtime and then offers cellular services to retail users.

However, a conventional cellular phone is designed to operate only using a particular cellular communication protocol. As such, a MVNO can integrate only the service regions where the cellular services are provided by networks using the same communication protocol. Traveling users are specifically impacted by inoperability of their cellular phones outside of a service region of the respective cellular network.

Therefore, there is a need in the art for a method and apparatus for providing multi-network cellular communications.

### SUMMARY OF THE INVENTION

In one embodiment, the present invention discloses a method and apparatus of communicating with a plurality of cellular communication networks employing different communication protocols using a single mobile endpoint device, e.g., a cellular phone. According to the present method, a user cellular phone is provided with a communication protocol conversion or switching module that is adapted for interfacing with different cellular networks operating in a region where the cellular phone is presently located. Namely, these different cellular networks employ different communication protocols. When a request for an incoming call or an outgoing call is received, the present method evaluates at least one performance factor in selecting one of the plurality of different communication protocols to service or process the incoming call or outgoing call.

### BRIEF DESCRIPTION OF THE DRAWINGS

The teachings of the present invention can be readily understood by considering the following detailed description in conjunction with the accompanying drawings, in which:

FIG. 1 depicts a high-level schematic diagram of a multi-system cellular service area according to one embodiment of the present invention;

FIG. 2 depicts a flow diagram of a method for providing multi-network cellular communications according to one embodiment of the present invention; and

FIG. 3 depicts a high-level block diagram of an exemplary multi-network cellular phone suitable for facilitating the method of FIG. 2 according to one embodiment of the present invention.

To facilitate understanding, identical reference numerals have been used, where possible, to designate identical elements that are common to the figures.

It is to be noted, however, that the appended drawings illustrate only exemplary embodiments of this invention and are therefore not to be considered limiting of its scope, for the invention may admit to other equally effective embodiments.

### DETAILED DESCRIPTION

The present invention will be generally described within the context of cellular communication networks and relates to a method and apparatus for providing multi-network cellular communications using a single mobile endpoint device, e.g., a cellular phone.

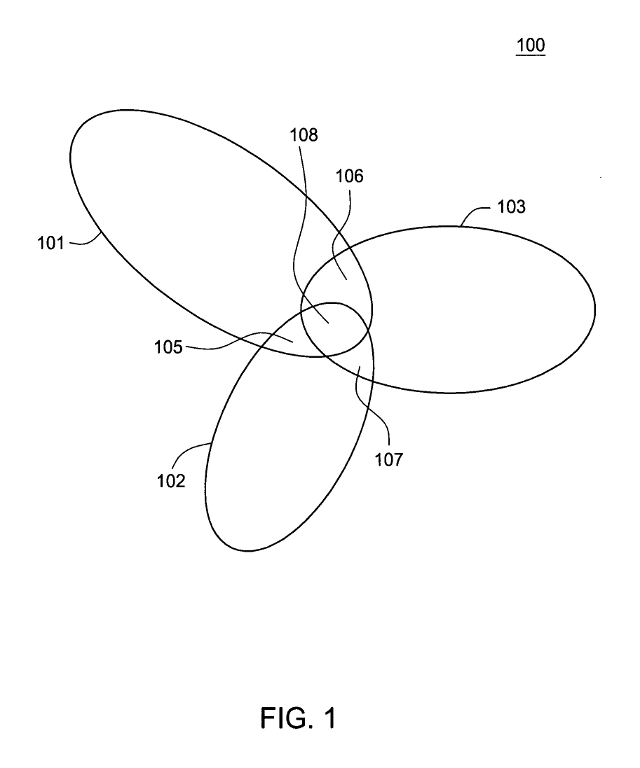

FIG. 1 depicts a high-level schematic diagram of a multi-system cellular service area 100 according to one embodiment of the present invention. In the depicted embodiment, the area 100 illustratively includes overlapping service areas or regions 101-103, however, in other embodiments, a number of the overlapping service areas may be either smaller or greater than three areas or regions. Each of the service areas 101-103 is serviced by a provider of cellular services that, in the respective area, operates its own network infrastructure. Regions 104-107 relate to portions of the regions where two of the service areas 101-103 overlap. Accordingly, a region 108 corresponds to a portion of the regions where all service areas 101-103 overlap.

In one embodiment, in each of the service areas 101-103, cellular networks may utilize different and non-compatible communication protocols, e.g., different modulation schemes, formats, link protocols, wavelength, signal structures, signal waveforms, and the like. Exemplary communication protocols include the Global System for Mobile Communications (GSM) protocol, the Code Division Multiple Access (CDMA) protocol (e.g., IS-95 or CDMA2000), the Wideband CDMA (WCDMA) protocol, the Time Division Multiple Access (TDMA) protocol, the American National Standard Institute-136 (ANSI-136) protocol and the like.

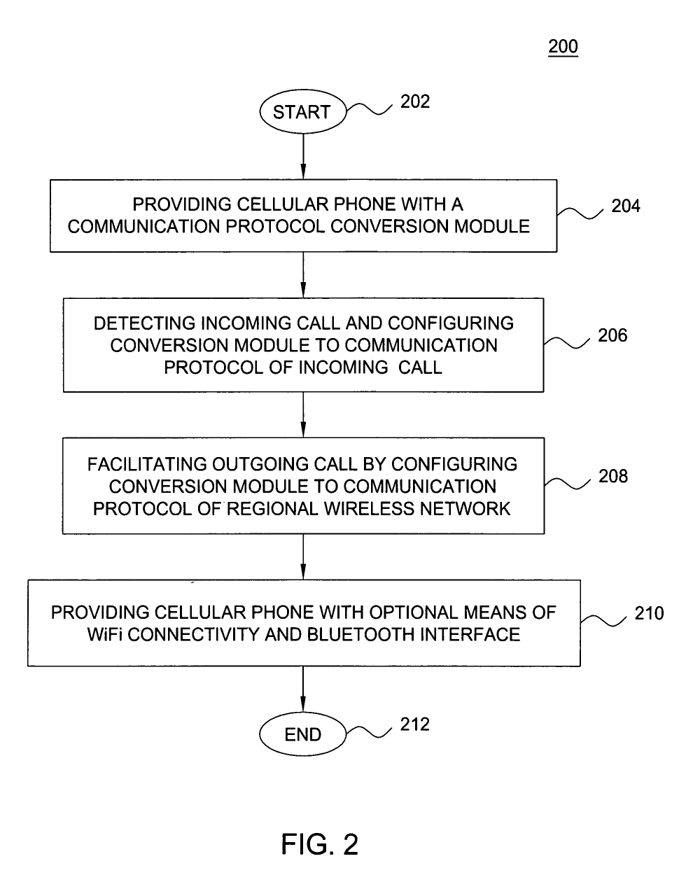

FIG. 2 depicts a flow diagram of a method 200 for multi-network cellular communications according to one embodiment of the present invention. The method 200 starts at step 202 and proceeds to step 204.

At step 204, a phone is provided with a multi-system cellular capability via a communication protocol conversion (or switching) module (CPCM). In one embodiment, the CPCM may have built-in hardware and/or software capabilities to support two or more cellular communication protocols or, alternatively, operate in a software-defined mode utilizing, e.g., the SoftRadio technology. In operation, a communication protocol used by such a cellular phone may be selectively changed from one protocol to another protocol, either manually by the user or automatically, to be compatible with the communication protocol of the cellular network operating in the region where the cellular phone is currently located.

At step 206, the multi-system cellular phone performs a routine of receiving an incoming call. Specifically, when the incoming call is detected in any of the service areas 101-109, the multi-system cellular phone automatically configures the CPCM to the communication protocol of the cellular network that initiated the incoming call (i.e., service request).

In one exemplary embodiment, in a stand-by mode, the CPCM automatically switches, with a pre-determined periodicity, between different communication protocols to detect the service request. In another embodiment, the CPCM may be pre-configured, either by a user manually or automatically, to the communication protocol of a known regional provider of the cellular services in the region where the multi-system cellular phone is currently located.

At step 208, outgoing calls from the multi-system cellular phone are facilitated from any one of the service areas 101-109. Specifically, such calls are handled using the communication protocol of the cellular network operating in the region where the multi-system cellular phone is currently located.

In one embodiment, determination of the communication protocol is provided by sequentially generating service requests using the communication protocols supported by the CPCM. In another embodiment, the CPCM may be pre-configured to the communication protocol of a known regional provider of the cellular services for the region where the phone is currently located. In yet another embodiment, when the phone is located in one of the service areas 105-108 where multiple communication protocols may be employed, a choice of the CPCM configuration can be defined by one or more factors (broadly defined as performance factors), such as the subscriber's location, signal strength (receive and/or transmit), the called party's location, cost of the airtime to the subscriber, time of day or day of week, subscriber specified preference, and the like. For example, if the subscriber's location is in an overlapped region covered by two service providers, e.g., edge of a region covered by a first service provider and a non-edge region covered by a second service provider, then the method may prefer using the protocol of the second service provider. In another example, the method will select the protocol associated with a higher signal strength. In another example, the method will select the protocol associated with a lower cost to the subscriber. In another example, the subscriber may set a predefined preference, e.g., for one protocol over another protocol, for one service provider over another service provider, and so on.

At step 210, the multi-system cellular phone may be provided with optional means of the wireless fidelity (WiFi) connectivity and/or the Bluetooth interface. Such multi-system cellular phone is capable of interfacing with both cellular and cordless communication networks. At step 212, the method 200 ends.

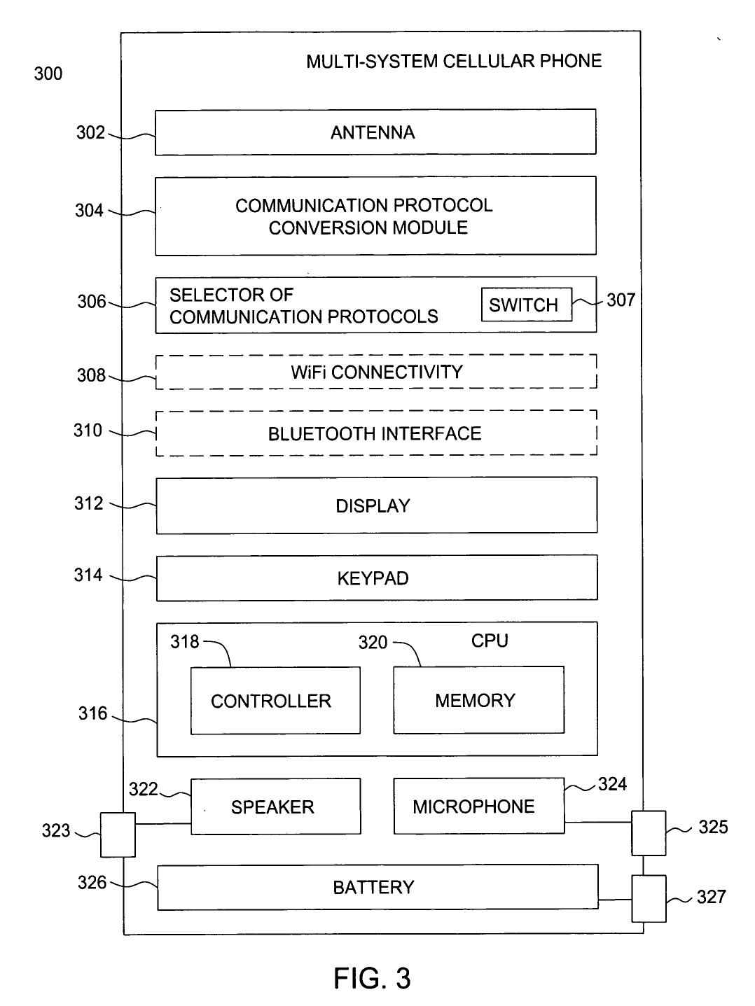

FIG. 3 depicts a high-level exemplary block diagram of an exemplary multi-network cellular phone 300 suitable for performing the method of FIG. 2 according to one embodiment of the present invention. For better understanding of the present invention, the reader should simultaneously refer to both FIGS. 2 and 3.

In one exemplary embodiment, the multi-network cellular phone 300 may comprise a radio-frequency (RF) antenna 302, a CPCM 304, a selector 306 of communication protocols, a display 312, a dual tone multi-frequency (DTMF) keypad 314, a central processor unit (CPU) 316, a speaker 322, a microphone 324, and a battery 326.

In the depicted embodiment, the cellular phone 300 may also include an optional module 308 for WiFi connectivity, an optional Bluetooth interface 310, optional connectors 323 and 325 for coupling to external speaker(s) (e.g., a headset, earpiece, and the like) and microphone(s), respectively (both not shown), and a connector 327 for coupling to a battery charging device (not shown). In another embodiment, the cellular phone 300 may also include an industry-standard slot for an optional memory card (e.g., flash memory card) and an Universal Serial Bus (USB) interface (both not shown).

The phone CPU 316 may includes a controller 318 (e.g., microprocessor-based controller) and a memory module 320. In operation, the phone CPU 316 control features and components of the multi-network cellular phone 300, including the CPCM 304. The memory module 320 may include various types of non-volatile, programmable, and random access electronic memory, such as flash memory, magnetic random access memory (MRAM), static random access memory (SRAM), dynamic random access memory (DRAM), and the like. The module 320 may further include a removable optional memory card (not shown) comprising an additional memory space and/or built-in programs or upgrades for the phone 300.

As discussed above in reference to FIG. 2, the CPCM 304 comprises hardware and/or software components for facilitating incoming and outgoing calls using a plurality of communication protocols, such as GSM, CDMA, WCDMA, TDMA, and ANSI-136 protocols. When such capabilities are implemented in a form of software, the corresponding programs and routines are generally stored in the memory module 320. In another embodiment (not shown), the CPCM 304 may also include an internal memory space for storing such programs and routines.

In one embodiment, the selector 306 provides configuration control for the CPCM 304. In one embodiment, the selector 306 includes a user-controlled manual switch 307. Each setting of the switch 307 corresponds to configuring the CPCM 304 for supporting one of the available cellular communication protocols. For example, the selector may analyze one or more performance factors associated with a plurality of different protocols and displays those results to a user. For example, the selector 306 may show two different airtime rates for two different available communication protocols, thereby allowing the user to manually select one of the available communication protocols.

In another embodiment, in a stand-by mode, the selector 306 periodically configures, for a pre-determined time interval, the CPCM 304 to various cellular communication protocols to identify which of such protocols are supported by the cellular networks at the current location of the phone 300.

When outgoing communications are possible via more than one cellular network, the selector 306 may automatically configure the CPCM 304 for operating within the network that meets additional criteria, such as the subscriber's location, signal strength (receive and/or transmit), the called party's location, cost of the airtime to the subscriber, time of day or day of week, subscriber specified preference, and the like. Prioritized list of such criteria may be stored, e.g., in the memory module 320. In yet another embodiment, the selector 306 may be implemented in a form of a software module or application that is stored in the memory module 320 and executed by the controller 318.

As discussed above in reference to FIG. 2, in a standby mode, the phone 300 may, e.g., sequentially switch between different communication protocols to detect a service request. In operation, using the CPCM 304 and selector 306, the phone 300 detects an incoming call, defines the communication protocol used by the cellular network that has initiated the request for service, and configures the CPCM 304 for supporting that communication protocol.

To facilitate an outgoing call, the phone 300 identifies communication protocol(s) of the cellular network(s) operating in the region where the phone is currently located. In one exemplary embodiment, the phone 300 sequentially initiates service requests using different communication protocols, detects which protocol was accepted by a regional cellular network, and configures the CPCM 304 for supporting that communication protocol.

When more than one cellular network accepts the request for service, the phone 300 may configure the CPCM 304 for executing the outgoing call through the network meeting additional criteria, as discussed above. Upon completion of the call, the phone 300 switches to a standby mode.

When only one communication protocol is supported at the current location of the phone 300, during the standby mode the CPCM 304 may remain configured to that communication protocol using, e.g., the switch 307 or, alternatively, a command generated by the phone CPU 316 and executed using the selector 306.

It should be noted that the present invention can be implemented in software and/or in a combination of software and hardware, e.g., using application specific integrated circuits (ASIC), a general purpose computer or any other hardware equivalents. In one embodiment, the present multi-network cellular communications module or process can be loaded into memory 320 and executed by processor or controller 318 to implement the functions as discussed above. As such, the present multi-network cellular communications process (including associated data structures) of the present invention can be stored on a computer readable medium or carrier, e.g., RAM memory, magnetic or optical drive or diskette and the like.

While the foregoing is directed to illustrative embodiments of the present invention, other and further embodiments of the invention may be devised without departing from the basic scope thereof, and the scope thereof is determined by the claims that follow.

What is claimed is:

1. A method for providing multi-system cellular communications in a mobile endpoint device, comprising:
detecting a plurality of different communication protocols used by a plurality of cellular networks;
receiving a request to send an outgoing call or a request to receive an incoming call;
evaluating at least one performance factor; and
selecting one of said plurality of different communication protocols to service said request to send said outgoing call or said request to receive said incoming call in accordance with said at least one performance factor.

2. The method of claim 1, wherein said plurality of different communication protocols comprises at least two of: a Global System for Mobile Communications (GSM) protocol, a Code Division Multiple Access (CDMA) protocol, a Wideband CDMA (WCDMA) protocol, a Time Division Multiple Access (TDMA) protocol, and a American National Standard Institute-136 (ANSI-136) protocol.

3. The method of claim 1, wherein said selecting one of said plurality of different communication protocols is performed automatically.

4. The method of claim 3, wherein said selecting one of said plurality of different communication protocols is performed automatically when said mobile endpoint device is in a standby mode.

5. The method of claim 3, wherein said selecting one of said plurality of different communication protocols is performed automatically in accordance with a pre-determined period of time, where each of said at least one performance factor is evaluated for each of said plurality of different communication protocols.

6. The method of claim 1, wherein said mobile endpoint device is a cellular phone.

7. The method of claim 1, wherein said selecting one of said plurality of different communication protocols is performed manually by a user.

8. The method of claim 1, wherein said at least one performance factor comprises at least one of: a subscriber's location, a signal strength, a called party's location, a cost of airtime, a time of day, a day of week, or a subscriber specified preference.

9. The method of claim 1, further comprising:
providing a WiFi connectivity or a Bluetooth connectivity.

10. A computer-readable medium having stored thereon a plurality of instructions, the plurality of instructions including instructions which, when executed by a processor, cause the processor to perform the steps of a method for providing multi-system cellular communications in a mobile endpoint device, comprising:
detecting a plurality of different communication protocols used by a plurality of cellular networks;
receiving a request to send an outgoing call or a request to receive an incoming call;
evaluating at least one performance factor; and
selecting one of said plurality of different communication protocols to service said request to send said outgoing call or said request to receive said incoming call in accordance with said at least one performance factor.

11. The computer-readable medium of claim 10, wherein said plurality of different communication protocols comprises at least two of: a Global System for Mobile Communications (GSM) protocol, a Code Division Multiple Access (CDMA) protocol, a Wideband CDMA (WCDMA) protocol, a Time Division Multiple Access (TDMA) protocol, and a American National Standard Institute-136 (ANSI-136) protocol.

12. The computer-readable medium of claim 10, wherein said selecting one of said plurality of different communication protocols is performed automatically.

13. The computer-readable medium of claim 12, wherein said selecting one of said plurality of different communication protocols is performed automatically when said mobile endpoint device is in a standby mode.

14. The computer-readable medium of claim 12, wherein said selecting one of said plurality of different communication protocols is performed automatically in accordance with a pre-determined period of time, where each of said at least one performance factor is evaluated for each of said plurality of different communication protocols.

15. The computer-readable medium of claim 10, wherein said mobile endpoint device is a cellular phone.

16. The computer-readable medium of claim 10, wherein said selecting one of said plurality of different communication protocols is performed manually by a user.

17. The computer-readable medium of claim 10, wherein said at least one performance factor comprises at least one of: a subscriber's location, a signal strength, a called party's location, a cost of airtime, a time of day, a day of week, or a subscriber specified preference.

18. The computer-readable medium of claim 10, further comprising:
providing a WiFi connectivity or a Bluetooth connectivity.

19. A mobile endpoint device for providing multi-system cellular communications, comprising:
means for detecting a plurality of different communication protocols used by a plurality of cellular networks;
means for receiving a request to send an outgoing call or a request to receive an incoming call;
means for evaluating at least one performance factor; and
means for selecting one of said plurality of different communication protocols to service said request to send said outgoing call or said request to receive said incoming call in accordance with said at least one performance factor.

20. The mobile endpoint device of claim 19, wherein said at least one performance factor comprises at least one of: a subscriber's location, a signal strength, a called party's location, a cost of airtime, a time of day, a day of week, or a subscriber specified preference.
